(19) United States
(12) Patent Application Publication
(10) Pub. No.: US 2009/0288457 A1
(43) Pub. Date: Nov. 26, 2009

(54) SECURTY DEVICE FOR DRUG VIALS

(75) Inventor: Michael J. Moldal, Littleton, CO (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: INNOVATIVE IDEAS, INC., Littleton, CO (US)

(21) Appl. No.: 12/470,889

(22) Filed: May 22, 2009

Related U.S. Application Data
(60) Provisional application No. 61/055,604, filed on May 23, 2008.

(51) Int. Cl. B65D 55/14; E05B 15/00

(52) U.S. Cl. 70/158; 70/286

(57) ABSTRACT

A security device includes a housing with a chamber defined by opposing sides, opposite end walls, a bottom wall, and a movable top member. The bottom wall includes one or more openings for receiving the body portions of correspondingly-sized drug vials while the openable top portions of the vials are securely retained inside the chamber. The top member is lockable in a closed position to prevent unauthorized access to the top portions of the vials. The body portions of the vials extend from the openings in the bottom wall and remain viewable and examinable while their top portions are secured. The top member is spaced from the bottom wall to prevent the vials from being pushed through the openings and fully into the chamber, and also to permit the device to be supported at a surface by one or more of the drug vials.

### CROSS REFERENCE TO RELATED APPLICATION

The present invention claims the benefit of U.S. provisional application Ser. No. 61/055,604, filed May 23, 2008, which is hereby incorporated herein by reference in its entirety.

### FIELD OF THE INVENTION

The present invention relates to security devices for preventing unauthorized access to drugs contained in vials.

### BACKGROUND OF THE INVENTION

It is known to provide lock-boxes for safely securing dangerous medications, to prevent access by unauthorized users. It is also known to provide limited-access devices for supporting various articles, while permitting access to the interior contents and/or the exteriors of the articles.

### SUMMARY OF THE INVENTION

The present invention provides a security device for preventing unauthorized access to medications and drugs. The device permits unobstructed viewing and examination of drug vials or containers and their labels, while preventing removal of the container caps when the device is locked. Drug vials are inserted through openings or apertures in the security device so that a lower portion of each drug vial protrudes from the device, while upper flange portions and caps of the drug vials are contained in a chamber of the device and are selectively blocked from removal by a lockable top member or plate that is movable between open and closed positions. The device itself may be supported on one or more of the drug vials that it secures, and may be stored in a medicine cabinet or other storage area or surface.

According to one aspect of the invention, a security device for storing drug vials includes a housing with a movable top member. The housing includes a support wall and opposing sides extending along the length of the support wall to form a chamber. The support wall includes at least one opening for receiving and holding one or more drug vials. The opening(s) are sized so that they can receive a vial body having a dimension slightly less than the cross dimension of the respective opening. The drug vials include larger top portions and/or caps that cannot pass through the openings in the support wall of the housing. The movable top member further defines and encloses the chamber, and is movable between an open position and a closed position. When the movable top member is in the open position, one or more of the drug vial(s) can be placed within (or removed from) the opening(s) in the support wall. When the movable top member is in the closed position, the top portions of the vials cannot be accessed or removed from vial bodies, and the vials cannot be removed from the housing, thereby preventing access to the vial contents. A lock member is provided for selectively engaging the movable top member and the housing to prevent removal of the movable top member.

Optionally, the movable top member is a substantially planar member with opposite edge portions that engage the opposing sides of the housing, such as in grooves or channels established in the opposing sides.

Optionally, the housing includes at least one end wall that extends from the support wall and spans between the opposing sides. The end wall and the movable top member each include respective apertures that are aligned with one another when the movable top member is in its closed position so that a shackle of the lock member may be engaged with the apertures to prevent removal of the movable top member.

Optionally, the movable top member is spaced from the support wall so that it is in close proximity to the vial top portions in the chamber. The vial top portions contact the movable top member when the security device is positioned at a support surface with the vial bodies resting on the support surface. The housing of the security device is thus supported above the support surface by the vials that contact the support surface.

Optionally, the openings in the support wall of the housing may number at least two or more, and/or may be of different sizes from one another, and/or may be of different shapes from one another.

According to another aspect of the invention, a method is provided for securing drug vials in a security device, the vials including bodies and top portions where the cross section of the bodies is smaller in dimension than the cross section of the top portions. The security device includes a housing with a bottom wall and opposing sides extending laterally along the length of the housing to form a chamber. The bottom wall includes a plurality of openings for receiving and holding one or more of the drug vials, where the openings have cross dimensions greater than the cross dimensions of the vial bodies, but less than the cross dimensions of the vial top portions. A movable top member is positioned at the housing and is movable between an open and a closed position. A lock member is provided for selectively engaging the movable top member in the closed position to prevent removal of the movable top member from the housing. The method includes moving or positioning the movable top member at the open position and positioning the drug vials with their bodies in the openings of the bottom wall of the housing so that the vial top portions are contained in the chamber of the housing. The movable top member is then closed and the locking member is positioned at the movable top member and locked to prevent removal of the movable top member and to prevent access to the top portions of the drug vials. The security device may then be positioned at a support surface with the housing spaced above the support surface and supported on the drug vials.

Thus, the present invention provides a security device that enables a user to securely store one or more drug vials with their top or openable portions rendered inaccessible to unauthorized persons, while the bodies of the vials are readily viewable and may be used to support the security device.

These and other objects, advantages, purposes, and features of the present invention will become apparent upon review of the following specification in conjunction with the drawings.

### BRIEF DESCRIPTION OF THE DRAWINGS

FIG. 1 is a perspective view of a security device in accordance with the present invention;

FIG. 2 is a side elevation of the security device of FIG. 1;

FIG. 3 is a top plan view of the security device of FIG. 1;

FIG. 4 is an end elevation of the security device, at the end having a lock;

FIG. 5 is another end elevation of the security device, at the end opposite the lock;

FIG. 6 is a perspective view of the security device with its movable top member partially removed and one drug vial partially removed;

FIG. 7 is a top plan view of the security device of FIG. 6;

FIG. 8 is a side elevation of the security device of FIG. 6;

FIG. 9 is a perspective sectional view of the security device of FIG. 1, taken along line IX of FIG. 4;

FIG. 10 is a sectional side elevation of the security device of FIG. 9;

FIG. 11 is a sectional side elevation similar to that of FIG. 10, but with drug vial caps in an inverted orientation; and

FIGS. 12A-12C are top plan views of security devices in accordance with the present invention, having various quantities and shapes of openings in the bottom walls.

### DESCRIPTION OF THE PREFERRED EMBODIMENTS

Access to medications by unauthorized users has led to school expulsions and criminal convictions of school-age children for trafficking their parents' medications, for example. Thus, there is a danger to the health and safety of young adults, and also a liability risk to authorized medication users, such as parents and grandparents with prescribed medications.

The present invention is directed to a security device that is relatively small, lightweight, and inexpensive, and which secures one or more drug vials by preventing access to the top or openable portions of the vials while keeping the vials in an organized and readily-viewable and examinable arrangement with their main body portions exposed. In addition, the device permits users who have difficulty opening child-safe containers to store the containers with their caps in a convenient configuration to maintain safety and security against access by children or other unauthorized persons. As will be more fully described below, the security device includes a lockable top or panel that is movable between opened and closed positions to either permit or preclude access to the top or openable portions of the drug vials retained at the device.

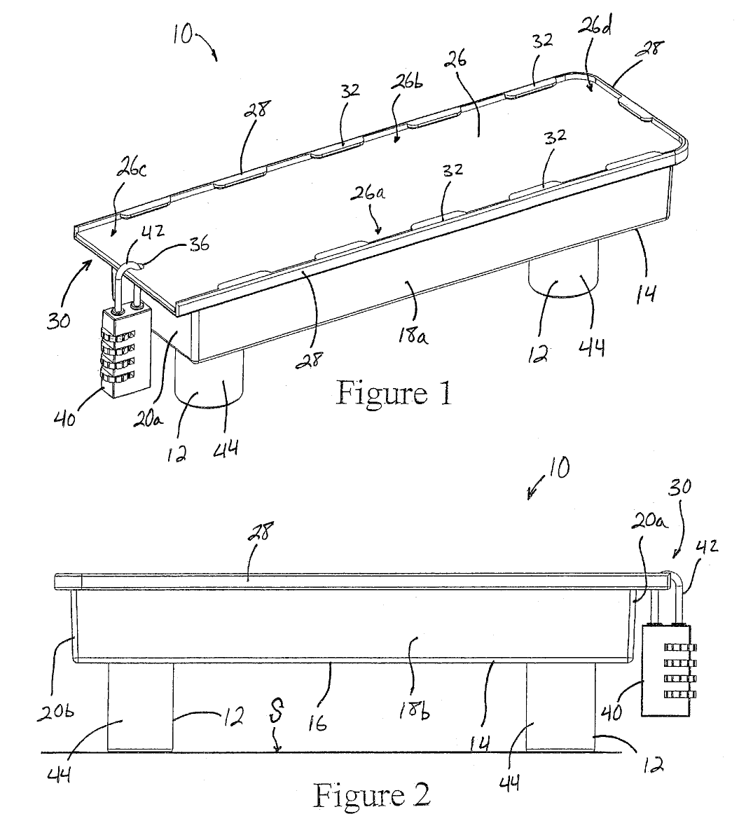

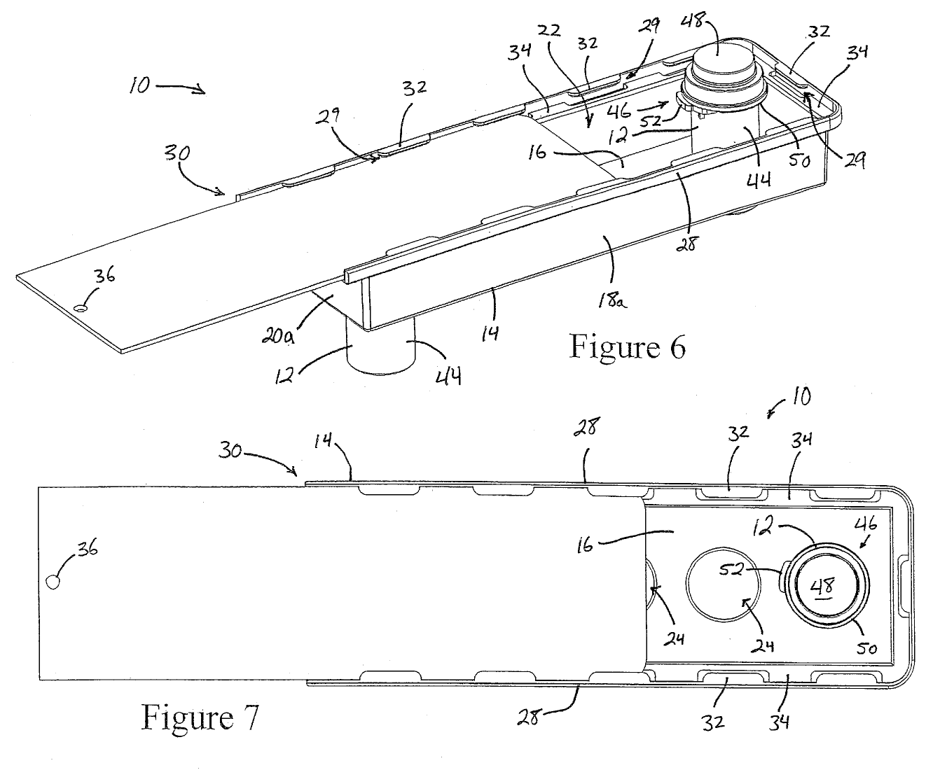

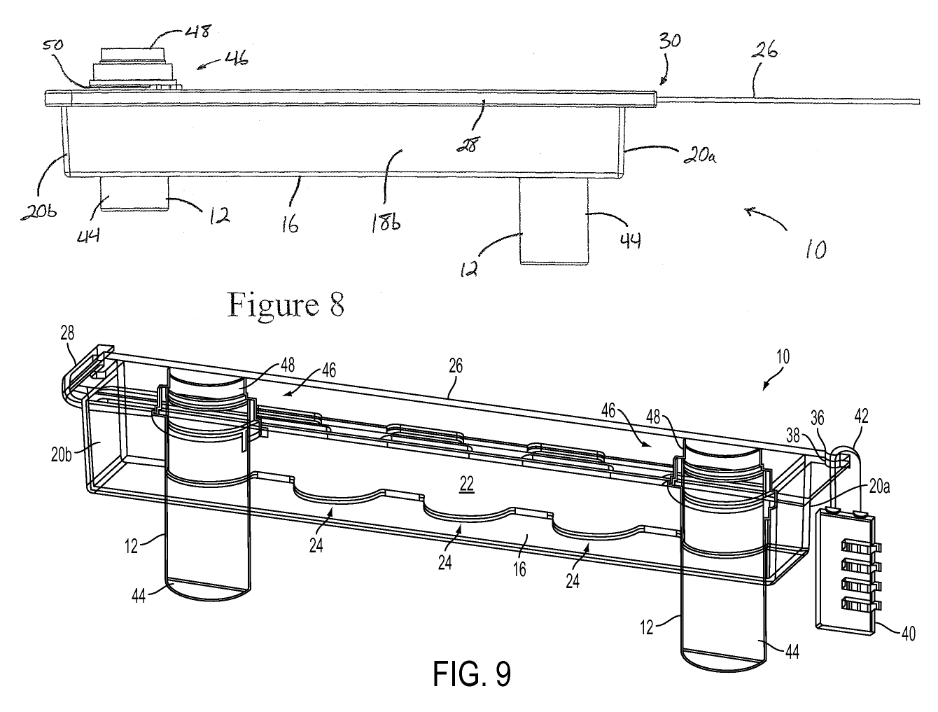

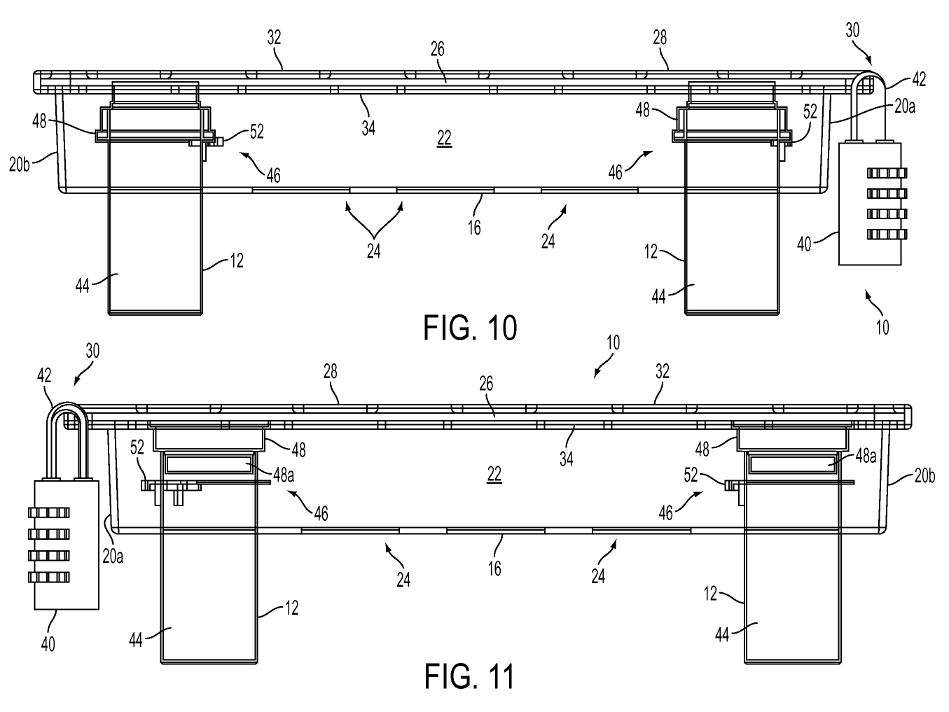

Referring now to the drawings and illustrative embodiments depicted therein, a security device 10 is provided for securing or securely storing a plurality of drug vials 12 (FIGS. 1-11). Security device 10 includes a housing 14 in the shape of a generally rectangular tub having a support wall or bottom wall 16, opposing sides 18a, 18b, and a pair of opposite end walls 20a, 20b cooperating to form an interior chamber 22 (FIGS. 6, 7, and 9-11). Bottom wall 16 includes a plurality of apertures or openings 24 (FIGS. 7 and 9-11) for receiving drug vials 12. A movable top or panel member 26 is provided at the top portion of housing 14 for securely enclosing chamber 22 to selectively permit or prevent access to the openable top portions of drug vials 12, as will be described in greater detail below. Support wall or bottom wall 16 is spaced below movable top member to provide space for a top portion of drug vials, as will also be described below.

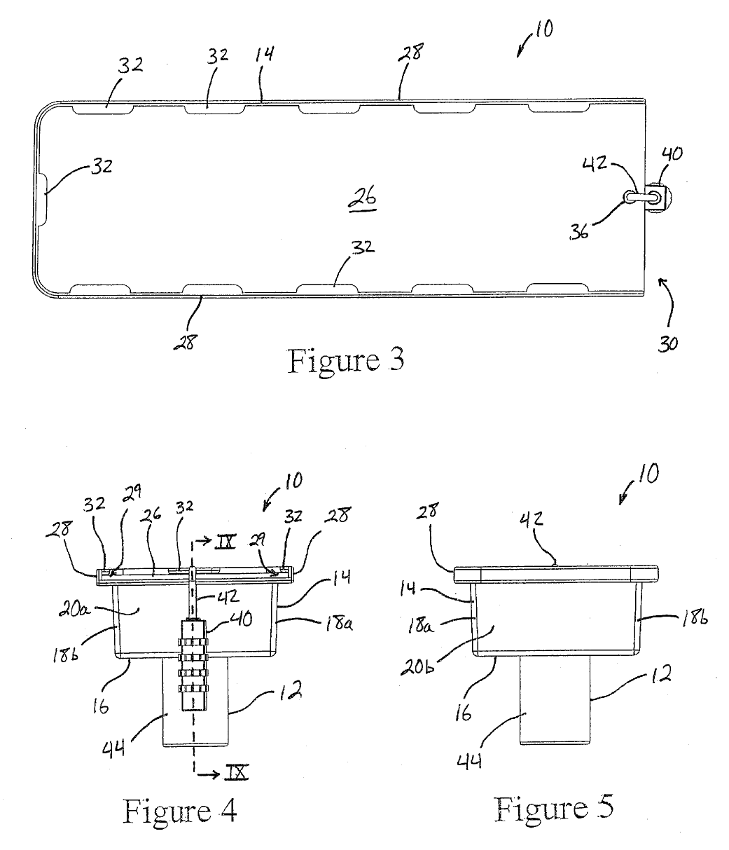

Opposing sides 18a, 18b and opposite end walls 20a, 20b extend generally upwardly from bottom wall 16 and cooperate to partially define chamber 22. A flange 28 in the form of an outwardly-directed lip or extension of the upper end portions of opposing sides 18a, 18b and opposite end walls 20a, 20b, is configured to movably or slidably receive movable top panel 26. When viewed from above (FIG. 3), flange 28 defines a generally C-shaped channel 29 (FIGS. 4 and 6) having elongate leg portions established above sides 18a, 18b that meet or join at a base end portion established above end wall 20b. The channel's leg portions terminate across from one another at an open end 30, which permits top panel 26 to be slidably installed or removed from the flange 28. Channel 29 is defined between a plurality of elongate tabs 32 and a bottom planar surface 34 of flange 28 (FIGS. 6 and 7). Spaced tabs 32 are in spaced arrangement around a perimeter of the upper end of flange 28, and may be positioned above corresponding apertures in planar surface 34 of flange 28 to facilitate manufacturing housing 14 by molding from resinous materials so that the housing (including sides 18a, 18b, end walls 20a, 20b, bottom wall 16, and flange 28) may be unitarily formed. Flange 28 thus receives movable top panel 26 in channel 29 so that opposite side edge portions 26a, 26b and a rear end portion 26d of top panel 26 engage the channel and may slide or move along the undersides of tabs 32 and along bottom planar surface 34. Optionally, flange 28 may include a hang-tag (such as an integrally-formed or adhesive-backed tag, not shown) at one end of the security device to facilitate display or storage on a peg or other projection.

Flange 28 and channel 29 of housing 14 are positioned so that when the top panel is moved or slid into the closed position, the vial caps are prevented from being unscrewed or pried from the drug vials (even if the top portions are somewhat accessible via an adjacent unfilled opening), and may be prevented from being accessed altogether by filling any unfilled openings with additional vials, as described below. In the illustrated embodiment, top panel 26 is a planar member that is moved or slid into place directly above the drug vial caps 48 when the drug vials 12 are installed at the openings 24 in bottom wall 16, thus preventing or disallowing access to the caps of the drug vials, and further preventing unauthorized users from pushing the drug vials fully into chamber 22 to access the top portions via openings 24. Top panel 26 also limits the extent to which the drug vials can be pushed into chamber 22, winch allows the security device to be supported above a support surface S (FIG. 2) by the drug vials.

It will be appreciated that an appropriate channel or groove for receiving edge portions of a top panel may be formed or established in sides and/or end walls of a housing, and without a flange. Optionally, a movable panel may be pivotally coupled to a portion of the housing via a hinge, such as a pair of hinge plates joined via a hinge pin, or a “living hinge” made of flexible plastic or the like, or may be coupled via other methods that permit moving the panel between an open position and a closed position, and without departing from the spirit and scope of the present invention.

An aperture 36 in front end portion 26c of movable top panel 26 aligns with a corresponding aperture 38 in the portion of flange 28 that extends outwardly from a top portion of end wall 20a. A lock or lock member 40 includes a shackle 42, a portion of which extends through apertures 36, 38 when top panel 26 is in the closed position (FIGS. 1-5, 10, and 11). Apertures 36, 38 may be slightly larger in diameter than the diameter of the shackle, such as apertures of about 0.26 inches in diameter for use with a shackle of about 0.25 inches or less in diameter. The apertures 36, 38 may be placed sufficiently close to the edges of the top panel and flange (at open end 30) so that lock 40 hangs substantially vertically from the apertures. Movable top panel 26 is precluded from sliding outwardly from flange 28 when shackle 42 is placed through apertures 36, 38. Elongate tabs 32 prevent movable top panel 26 from being lifted or pried from the channel 29 and away from the flange 28. Access to chamber 22 is thus discouraged or precluded when movable top panel 26 is in the closed position and lock 40 is locked with shackle 42 extending through the apertures in top panel 26 and flange 28.

Drug vials 12 typically include a body 44 and a top or openable portion 46 including a cap 48 (FIGS. 6 and 9-11). Vial body 44 is generally cylindrical in shape and has a substantially constant diameter along its length. Top portion 46 may include a flange 50 of greater diameter than vial body 44, and may further include a child lock or safety feature 52 that releasably engages a portion of cap 48 to limit removal of the cap. Cap 48 may include female threads or other attachment features along an interior surface for engaging male threads or other cooperative features at top portion 46 of drug vial 12, for fastening the cap to the drug vial. The vials may come in various shapes and sizes, including standard cylindrical sizes such as 1.30-inch cross dimension or outer diameter, and other diameters and/or shapes including rectangular or square, for example.

Typically, cap 48 includes a cylindrical top portion 48a of the similar size as the inner diameter of vial body 44, which permits the cap to be inverted and its cylindrical top portion 48a inserted into top portion 46 of drug vial 12. Optionally, cylindrical top portion 48a of cap 48 includes male threads for engaging corresponding female threads on an inner surface of the top portion 46 of drug vial 12. Thus, cap 48 may be installed in a “convenience configuration” (FIG. 11) that permits removal of the cap by rotation, but without the use of safety feature 52. The “convenience configuration” may normally be useful for persons having arthritis or low-grip strength, for example, and especially when there is little or no risk of access to drug vials 12 by children. However, as shown in FIG. 11, drug vials 12 having their caps 48 in the inverted or convenience configuration may be secured in chamber 22 without risk of access by children or other unauthorized persons.

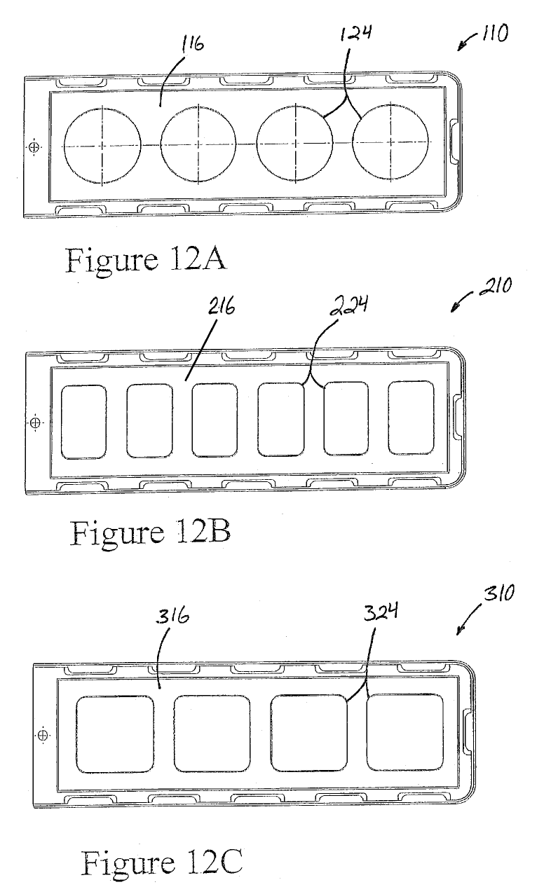

Optionally, and with reference to FIGS. 12A-12C, a security device 110 may include a support wall or bottom wall 116 defining a plurality of large circular openings 124 (FIG. 12A), such as to accommodate extra-large cylindrical drug vials. It is further envisioned that security devices of the present invention may include non-circular openings in their bottom walls, such as, for example, a security device 210 having a bottom wall 216 defining a plurality of rectangular openings 224 (FIG. 12B), or another security device 310 having a bottom wall 316 defining a plurality of square openings 324 (FIG. 12C). Thus, substantially any number, sizes, or shapes of openings may be established at the bottom wall of the security device to accommodate various different sizes and shapes of drug vials for secure storage. In addition, different sizes and shapes of openings may be established at a single bottom wall to simultaneously accommodate drug vials of different sizes and shapes in a single security device. Optionally, the openings in the bottom wall of the housing may be fitted with reduced-diameter inserts to adapt a given security device so that it can accommodate and secure different sizes and/or shapes of drug vials, without need for a separate security device having a different configuration of openings. For example a standard security device may be provided with relatively large openings that will receive correspondingly large drug vials, and that can also be fitted with different sizes and shapes of adapters (such as annular rings with lock-in features) to receive different sizes and shapes of drug vials. It will be appreciated that the openings for receiving the drug vials may optionally be located in the movable top panel (or in both the bottom wall and the top panel, with drug vial caps of opposed drug vials in contact or in close proximity to one another in the chamber) while providing similar security for the drug vials, and without departing from the spirit and scope of the present invention.

The security device may be made in substantially any size or configuration in order to receive and prevent access to one or more drug vials. For example, the length of the security device may be less than about 11.5 inches and the width may be less than about 3.75 inches, with a height or depth of about 1.65″, such as to fit in a standard household medicine cabinet and to accommodate standard sizes of drug vial top portions with caps. It will be appreciated, however, that the security device may be sized to fit as little as one single drug vial, or as many drug vials as desired. The openings for receiving the drug vials may be oriented and aligned in substantially any arrangement. For example, the security device may be provided with seven openings for receiving seven different drug vials, such as one vial for each day of the week, or for seven different types of drugs. The security device may also be stackable, so as to allow two or more security devices to be stacked in a medicine cabinet or other storage area. The security device may also include two or more rows of openings for accommodating many different drug vials, and may be stored in a drawer or other area that can accommodate housings having larger widths and/or lengths.

The security device may be formed from high-strength engineered plastics or polymeric materials (including virgin and/or recycled plastics), metals, composites, wood, or other sufficiently strong materials. The housing of the security device may be made of lightweight, high-strength plastic, such as acrylonitrile butadiene styrene (ABS), while the top member may be made of polymethyl methacrylate (i.e. PMMA or “acrylic glass”), polymethyl 2-methylpropanoate, or the like, so as to provide high strength and ease of handling while minimizing costs and weight, and may preferably be made of translucent or transparent materials to enhance visibility of the top portions of the drug vials, or may be manufactured in substantially any color or degree of opacity. Optionally, the housing and/or the top panel of the security device may be printed or molded with text and/or graphics or other indicia, such as to identify the manufacturer or distributor, or to provide instructions regarding use of the security device, or to provide other information.

Lock 40 may be substantially any conventional lock, such as a padlock or the like having a solid or cable-type shackle, and may be a combination lock resistant to lock picks or similar devices, or may be a key lock, a biometric-sensor lock (e.g. a fingerprint scalier), or substantially any other openable lock that is removable from the housing. A combination lock, such as lock 40 of the illustrated embodiment, may include four tumblers that permit a user to select from 10,000 different lock combinations, for example. Lock member 40 may be relatively light in weight to prevent imbalance or tipping of security device 10. Suitable combination locks may include, for example, the PRESTOLOCK 4400 padlock, available from CCL Security Products of Wheeling, Ill., or the TRAVEL LOCK 646D or TRAVEL LOCK 121 padlocks, available from Master Lock Company LLC, of Oak Creek, Wis. Optionally, an integral lock may be established at or near the flange of the housing to releasably engage the movable top panel in its closed position and thereby prevent its unauthorized removal from the housing. It will be appreciated that an integral lock would negate the use of a separate lock that is removed from the housing to permit the top member to open for access to the chamber and its contents. It is further envisioned that the lock may provide a visual and/or aural or other sensory indication that the security device has been tampered with and that the drugs contained in the vials may have been accessed by an unauthorized person.

Accordingly, an authorized user may securely store one or more drug vials such that they may be readily viewed and examined while their contents remain inaccessible to unauthorized persons. To load or fill the security device, the user unlocks the lock member, if necessary, and removes its shackle from the apertures in the top panel and flange. The top panel is then moved or slid at least partially out of its channel or groove into an open position (FIGS. 6-8) to permit access to the chamber and the openings in the bottom wall of the housing. One or more drug vials are inserted body-first into the openings until a flange or cap contacts the bottom wall and prevents further travel of the drug vials through the openings. Once the desired drug vials are installed, the top panel is slid or moved back to its closed position and the lock shackle is replaced and locked, whereby the vials are prevented (by the closed top panel) from being pushed fully into or through the chamber of the security device, and whereby access to the top portions of the vials is precluded. The procedure for accessing the contents of drug vials secured in the housing is substantially the same as for filling the security device, except that the drug vials stored in the openings of the housing may be fully or partially removed from the openings (or accessed while still fully inserted into the openings) when the top panel is in the open position, before being replaced in the openings with their respective caps secured in either a child-safe or convenience configuration before the top panel is closed.

Depending on the size and weight balance of the security device and the drug vials that it secures, a user may place the security device on a support surface so that only the drug vials contact the surface. The security device is thus supported in spaced arrangement above the support surface via contact of one or more drug vial caps or openable top portions with the top panel of the security device. Optionally, in order to evenly support or balance the security device and the vials it secures, a user may install one or more extra drug vials at opposite ends of the housing. The user may also install extra drug vials in any unfilled opening, such as to preclude access to filled drug vials through openings that would otherwise be left unfilled. One or more empty drug vials may be provided with the security device, such as to demonstrate and/or provide written instructions regarding its use, or regarding drug prevention, lock member information, child or elderly patient protection information, or to facilitate balance and security, as noted above. Optionally, the security device may be supported by the housing, with the drug vials hanging from their top portions, which are sized so as not to pass through the openings in the bottom wall of the housing.

Thus, the security device provides a product that may be used by authorized drug users or trusted persons, such as in households, nursing homes, hospitals, pharmacies, or substantially any place where drugs are stored in drug vials. Authorized or trusted users may thereby prevent access by unauthorized users, such as children or other at-risk persons. The security device may be used or sold or distributed by pharmaceutical drug companies, pharmacies, grocery stores, doctors, dentists, health care providers, hospitals, veterinary hospitals, school board administrators, daycare facilities, parent-teacher associations, city governments, city and county health departments, police departments, and the like, to prevent access to certain drugs by unauthorized users. Optionally, the security device may be used for other applications, such as for securing or organizing substantially any items that may be contained in vials or jars or other containers having caps or flanges or the like.

Changes and modifications in the specifically described embodiments may be carried out without departing from the principles of the present invention, which is intended to be limited only by the scope of the appended claims, as interpreted according to the principles of patent law including the doctrine of equivalents.

1. A security device for storing one or more drug vials wherein the vials are formed with a body and top portion, the cross section of said body being of a dimension less than the cross section of the top portion, said security device comprising:
a housing having a support wall and opposing sides extending laterally along the length of the housing to form a chamber;
a movable top member securable between said opposing sides to further define the chamber;
said support wall spaced from said movable top member and having at least one opening for receiving and holding at least one drug vial, said one or more openings having a cross dimension greater than that of the vial body, but less than that of the vial top portion;
said top member being movable between an open and closed position wherein when said movable top member is in said open position, the drug vial can be placed within the opening or removed therefrom, and when said movable top member is in said closed position, the vial top portion cannot be accessed or removed from said housing thereby preventing removal of the vial contents;
a lock member, said lock member adapted to selectively engage said movable top member to prevent removal of said movable top member from said housing.

2. The security device of claim 1, wherein the vial body extends below the support wall when positioned in the opening.

3. The security device of claim 1, wherein said movable top member comprises a substantially planar member having opposite edge portions adapted to engage said opposing sides of said housing.

4. The security device of claim 3, wherein said opposing sides comprise channels for slidably receiving said opposite edge portions of said substantially planar member.

5. The security device of claim 1, further comprising:
at least one end wall extending upwardly from said support wall and spanning between said opposing sides of said housing, said end wall comprising a first aperture;
a second aperture at an end of said movable top member, said second aperture being substantially aligned with said first aperture when said movable top member is in the closed position; and
said lock member comprising a shackle adapted to simultaneously engage said first aperture of said end wall and said second aperture of said movable top member to thereby prevent removal of said movable top member.

6. The security device of claim 5, wherein said lock member comprises a combination lock.

7. The security device of claim 1, wherein said movable top member is spaced above said support wall so as to be in close proximity to the vial top portions in said chamber, wherein the vial top portions contact said movable top member when said security device is positioned at a support surface with the vial body resting on the support surface to thereby support said security device with said support wall spaced above the support surface.

8. The security device of claim 1, wherein said support wall defines at least two of the openings for receiving at least two drug vials.

9. The security device of claim 8, wherein at least two of the openings are of different sizes or shapes.

10. The security device of claim 1, wherein said security device comprises a polymeric material.

11. The security device of claim 10, wherein at least one of said housing and said movable top member comprises a translucent material.

12. The security device of claim 11, wherein at least one of said housing and said movable top member comprises a transparent material.

13. The security device of claim 1, wherein said housing is about 11.5 inches in length and about 3.75 inches in width.

14. A security device for storing drug vials wherein the vials are formed with a body and top portion, the cross section of said body being of a dimension less than the cross section of the top portion, said security device comprising:
a housing, said housing having a bottom wall, opposing sides extending laterally along the length of the housing, and opposite end walls extending along the width of the housing to form a chamber, said bottom wall having a plurality of openings for receiving and holding one or more drug vials, the openings having a cross dimension greater than that of the vial body, but less than that of the vial top portion;
said housing further including a movable top member cooperative with said housing to further define and enclose said chamber, said top member being moveable between an open and closed position wherein when said movable top member is in said open position, one or more drug vials can be placed within one or more of the openings or removed therefrom, and when said movable top member is in said closed position, the vial top portions cannot be accessed or removed from the vial bodies and the vials cannot be removed from said housing, thereby preventing removal of the vial contents; and
wherein said movable top member is spaced above said bottom wall so as to be in close proximity to the vial top portions in said chamber, wherein the vial top portions contact said movable top member when said security device is positioned at a support surface with the vial bodies resting on the support surface to thereby support said security device with said housing spaced above the support surface.

15. The security device of claim 14, further comprising a lock member, said lock member adapted to selectively engage said movable top member and said housing to prevent removal of said movable top member from said housing.

16. The security device of claim 15, further comprising:
a first aperture in a first of said end walls of said housing;
a second aperture at an end of said movable top member, said second aperture being substantially aligned with said first aperture of said first end wall when said movable top member is in the closed position; and
said lock member comprising a shackle adapted to simultaneously engage said first aperture of said first end wall and said second aperture of said movable top member to thereby prevent removal of said movable top member.

17. The security device of claim 14, wherein said housing is about 11.5 inches in length and about 3.75 inches in width.

18. The security device of claim 14, wherein said movable top member is spaced above said bottom wall of said housing so as to secure a vial cap at the top portion of the drug vial when the vial cap is in an inverted position and said movable top member is in said closed position.

19. A method of securing drug vials in a security device, said method comprising:
providing a plurality of drug vials having bodies and top portions, the cross section of the bodies being of a dimension less than the cross section of the top portions;
providing a security device having a housing including at least a bottom wall and opposing sides extending laterally along the length of the housing to form a chamber, said bottom wall having a plurality of openings for receiving and holding one or more of the drug vials, the openings having a cross dimension greater than that of the vial body, but less than that of the vial top portion;
providing a movable top member at the housing, the top member being moveable between an open and closed position;
providing a lock member adapted to selectively engage the movable top member and the housing to prevent removal of the movable top member from the housing;
moving the movable top member to the open position;
positioning the bodies of the drug vials in the openings of the bottom wall so that the top portion is in the chamber of the housing;
moving the movable top member to the closed position;
locking the lock member at the movable top member and the housing to prevent removal of the movable top member and to prevent access to the top portions of the drug vials; and
positioning the security device at a support surface with the housing spaced above the support surface and supported on the drug vials.

20. The method of claim 19, wherein said moving the movable top member to the open position and said moving the movable top member to the closed position comprise sliding the movable top member along grooves provided in the opposing sides of said housing.
